(19) United States
(12) Patent Application Publication
(10) Pub. No.: US 2015/0233337 A1
(43) Pub. Date: Aug. 20, 2015

(54) THERMAL COLD START SYSTEM WITH MULTIFUNCTION VALVE

(71) Applicant: BorgWarner Inc., Auburn Hills, MI (US)

(72) Inventor: John Shutty, Clarkston, MI (US)

(21) Appl. No.: 14/421,246

(22) PCT Filed: Aug. 8, 2013
(86) PCT No.: PCT/US2013/054087

§ 371 Date: Feb. 12, 2015

Related U.S. Application Data
(60) Provisional application No. 61/691,184, filed on Aug. 20, 2012.

(51) Int. Cl. F02N 19/10; F01P 7/16; F01P 11/02

(52) U.S. Cl. CPC F02N 19/10; F01P 11/02; F01P 7/16; F01P 2007/168

(57) ABSTRACT

A thermal system with a multifunction valve for improving the cold start procedure for a vehicle internal combustion engine. The multifunction valve regulates and apportions the flow of coolant from the engine to either or both of the coolant pump and the radiator.

### CROSS-REFERENCE TO RELATED APPLICATIONS

This application is related to U.S. patent application Ser. No. 61/691,176, entitled “Thermal System Cold Start Control Method” (DKT12091) and U.S. Patent Application No. 61/691,180, entitled “Thermal System Cold Start Layout Circuit” (DKT12092), each being filed on the same day as the present application.

### TECHNICAL FIELD

The present invention relates to the efficiency of internal combustion engines, and more particularly to a thermal system with a multifunction valve for improving the speed and efficiency of cold start-up of the engines.

### BACKGROUND OF THE INVENTION

One of the ways to improve the efficiency of internal combustion engines is to accelerate the warm-up during cold starts. A method for performing this acceleration is to initially prevent the coolant pump from operating until key areas of the engine and oil reach a certain temperature. This isolates the large quantity of coolant in the radiator and the engine which are at the cold start temperature. Significant time and energy are typically needed to bring these large quantities of coolant up to a desired temperature.

Another way to improve the efficiency of internal combustion engines via accelerated initial heating of the engines and other vehicle components is to circulate coolant through exhaust-to-coolant heat exchangers. This approach, however, requires operating the coolant pump at medium to high speeds. It may also require heating a large volume of coolant including the quantity in the radiator and/or in the engine.

These two approaches to efficiency improvement lead to a conflict relative to the operation of the coolant pump.

It is an object of the present invention to provide a layout circuit system which improves the efficiency of an internal combustion engine via initial warm-up of the engine and vehicle components from a cold start. It is another object to provide a system for simultaneously heating the engine and other components, such as the passenger compartments, rear axle, transmission and the like from a cold start, and doing so in a faster and more efficient manner.

### SUMMARY OF THE INVENTION

The present invention meets the above objectives by providing a method and system which provides faster and simultaneous warm-ups from cold starts of internal combustion engines and other vehicle components and systems. The invention improves the efficiency of the engines during cold starts.

In preferred embodiments of the invention, thermal system layout circuits are provided which use unique routing layouts for the engine coolant system which can be combined with a multifunction valve and other valving mechanisms, together with programmed control systems. In one embodiment, valves in the coolant routing layout allow the coolant pump to run coolant to exhaust heat exchangers and then to various vehicle components while coolant flow is prevented to the engine and radiator. The volume of coolant fluid that needs to be warmed by the engine and heat exchanger is significantly reduced. In addition, a multifunction valve member is used to assist in the transition from the cold-start to normal engine operation in a faster and smoother manner.

The smaller volume of coolant warmed by the heat exchanger can be routed to one or more of the vehicle components and heating systems, such as the passenger compartment heater core, the transmission, and the rear axle. This acts to warm up the vehicle oil and other fluids in a faster manner which in turn allows the vehicle to be more efficient.

The multifunction valve member is utilized as the vehicle thermostat component and is internally programmed to prevent operation of the vehicle engine cooling system through the radiator, or allow partial or full passage of coolant to the radiator, as necessary or programmed to do so. The multifunction valve can route coolant from the engine through a bypass line around the radiator, or act as a proportioning valve and let partial fluid flow to both the radiator and the bypass line. It can also be programmed to prevent flow to the engine or allow partial full flow to the engine. The multifunction valve is preferably operated by a programmed electronic system through data supplied by various sensors, typically temperature sensors.

Additional objects, features, and benefits of the present invention will become apparent when viewed in light of the detailed description of the preferred embodiments when taken in conjunction with the attached drawings and claims.

### BRIEF DESCRIPTION OF THE DRAWINGS

FIG. 1 schematically depicts a preferred embodiment of the present invention.

FIG. 2 is a graph depicting the use of a preferred embodiment of the invention.

FIG. 3 schematically depicts another preferred embodiment of the present invention.

FIG. 4 depicts another embodiment of the invention which includes a multifunction valve.

FIGS. 5A, 5B and 5C schematically illustrate multifunction valves which can be used with the present invention.

FIG. 6 schematically depicts a method of use of preferred embodiments of the invention.

### DESCRIPTION OF PREFERRED EMBODIMENTS

The present invention is described herein with respect to certain embodiments for use with vehicles, such as automobiles and trucks. It is to be understood, however, that the embodiments described herein are only representative embodiments and that other embodiments and variations thereof will be apparent from the following descriptions to persons of ordinary skill in the art. These additional embodiments and variations are to be included within the scope of the invention if they are set forth within the scope, definition and meaning of the claims.

In addition, although the invention is described herein with respect to its use in vehicles, it is to be understood that the invention can be utilized in other systems and environments, such as, for example, industrial engines and industrial systems. These other uses are also to be included within the scope and meaning of the present invention and defined by any claims which are not limited to vehicles.

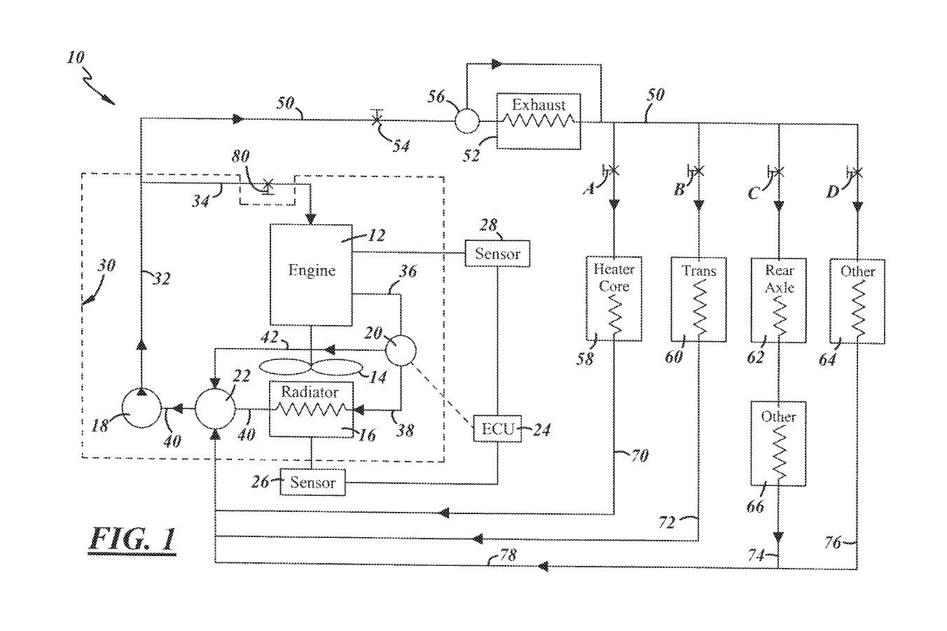

Preferred embodiments of the layout circuit and process invention are shown in FIG. 1 and referred to generally by the reference numeral 10. The layout circuit includes a vehicle internal combustion engine 12, a cooling fan 14, a radiator 16, a coolant pump 18, a thermostat 20 and a mixing valve 22 in a fluid coolant layout circuit. The vehicle can be any of the known vehicles today, such as an automobile or truck, which use internal combustion engines. The engine also can be any of the conventional internal combustion engines in use today in automobiles, trucks and other vehicles.

The system also includes an electronic control unit (ECU) which is in use in one form or another in most vehicles today, such as ECU 24 shown in FIG. 1. The ECU accumulates data from a number of sensors or sources in order to operate and regulate the various systems of the engine and vehicle. The sensors can be used to measure temperatures of fluids or components, pressures, speeds (e.g. RPM), and the like. In the layout circuit shown in FIG. 1, only representative temperature sensors 26 and 28 are shown for clarity. Not all of the various sensors in use in vehicles today, or which can be used with the present invention, are included.

A system which is relatively conventional today is included in the dashed box 30 in FIG. 1. At start up, the coolant pump 18 circulates coolant through lines 32 and 34 to the engine 12. After circulating through the engine, the coolant passes through line 36 from the engine to the thermostat 20 and then through line 38 to the radiator 16 and back to the pump through line 40. When the engine is cold, the thermostat may route the coolant from the engine through bypass line 42 and mixing valve 22 back to the pump 18. When the engine and coolant are warmer, the thermostat routes the coolant through line 38 to the radiator where it is recirculated through the engine by the coolant pump.

In one cold-start system and process, the coolant pump is kept in an inoperative condition (by the ECU) and the engine is used to heat up the coolant and oil which have remained in the engine block when the engine coolant pump was turned off. When the temperature of the coolant in the engine reaches a desired temperature, such as by being sensed by temperature sensor 28, the coolant pump is turned on and coolant stored in the radiator and the rest of the coolant system is circulated through the engine.

With the engine heating up more quickly, the engine and engine oil are also heated up more quickly which acts to reduce the amount of undesirable exhaust materials to be exhausted to the atmosphere through the exhaust system of the vehicle. In addition, a faster warm-up of the engine allows the catalytic converter in the vehicle (through which the engine exhaust passes) to also be heated more quickly. This also acts to reduce the amount of undesirable materials to be exhausted into the atmosphere. The faster warm up of the oil allows warmer oil to be circulated more quickly to the engine and vehicle components which utilize the oil. This reduces friction and improves fuel consumption.

As shown in FIG. 1, the coolant forced by the coolant pump 18 into line 32 is also forced into line 50 into and through an exhaust-to-coolant heat exchanger 52. A valve 54 can be used to selectively open and close line 50 to the heat exchanger 52. Another valve 56 can be used to selectively create a by-pass of line 50 around the heat exchanger 52. The valve 56 also could be a proportioning type valve which allows full, partial, or no flow to the bypass. In this manner, the change of the flow from the heat exchanger to the bypass could be accomplished over a period of time.

Once the coolant in line 50 is heated (warmed-up) by the exhaust-to-coolant heat exchanger 52, it then can be used to heat (warm-up) other components and systems in the vehicle, such as the heat exchanger 58 (heater core) for the passenger cabin heater system, the heat exchanger for the fluid in transmission 60, the heat exchanger for the oil in the rear axle 62 and/or heat exchangers for other vehicle components and systems 64 and 66. Optional shut-off valves A, B, C and D can be controlled by the ECU to selectively allow the warmed fluid from line 50 to selectively pass through one or more of the heat exchangers 58, 60, 62, 64 and/or 66.

The heat exchangers that are warmed by the heated fluid in line 50 can be positioned in series or in parallel. As shown in FIG. 1, heat exchangers 58, 60, 62 and 64 are in series, while heat exchangers 62 and 66 are arranged in parallel. Any combination of series or parallel arrangements can be provided.

The fluids passing through heat exchangers 58, 60, 62, 64 and 66 are directed back to the mixing valve 22 through lines 70, 72, 74, 76 and 78. This can be accomplished in any desired manner; the system shown in FIG. 1 sets forth only one manner in which this can be accomplished.

The inventive layout circuit embodiment and process shown in FIG. 1 also includes a shut-off valve 80 positioned in line 34. The valve 80 is positioned between the pump 18 and the engine 12 and is controlled by the ECU or another control member (not shown) in the vehicle.

In one preferred method of cold-start of an engine using the layout circuit as shown in FIG. 1, the valve 80 is initially closed, valve 54 is open and bypass valve 56 is initially closed. Since there is no flow of coolant circulated through the engine block, the relatively small amount of coolant in the engine heats up more rapidly, along with the engine oil. This improves the efficiency of the combustion of fuel in the engine and helps minimize the exhaust of undesirable materials into the atmosphere.

At the same time in the initial cold-start process in accordance with the invention, the system simultaneously circulates an amount of coolant through the exhaust heat exchanger where it is separately warmed up. The heated fluid is then returned to the pump through one or more of lines 70, 72, 74 and 76, allowing it to warm the engine compartment (on cold days), the transmission fluid, the rear axle fluid and/or other components as desired. The heated fluid can be circulated through whatever component is desired at the time, depending on the temperature of the environment and other conditions, such as the temperature of the initial coolant and other fluids. Valves A, B, C and D can be opened or closed for this purpose.

Once the coolant in the engine reaches a predetermined temperature, the valve 80 is opened allowing the coolant to be pumped and circulated through the engine in a normal manner.

Similarly, once the temperature of the coolant in line 50 downstream of the exhaust heat exchanger 52 reaches a predetermined temperature, the bypass valve 56 is opened allowing coolant to bypass the exhaust heat exchanger 52. This prevents the coolant from becoming too hot.

The valve 56 can be proportionally a valve which regulates the amount of fluid passing through it, rather than a simple ON-OFF valve. This allows the amount of coolant passing through the exhaust heat exchanger to be diminished gradually over time until the valve 56 is fully open.

Valve 54 is an optional valve. If the system is equipped with this valve, it is left opened during cold start situations in order to allow coolant to flow to the exhaust-to-coolant heat exchanger. Once the secondary (auxiliary) devices, such as 58, 60, 62 and 64 are warmed to their normal operations temperatures, the valve 54 can be closed or left opened. If the temperature of any the auxiliary devices get too high, then valve 54, if closed, can be reopened, along with bypass valve 56 and appropriate valves 58, 60, 62 and/or 64, in order to allow coolant to reduce or moderate the temperature of the fluid in the auxiliary device.

If the specifications and characteristics of a particular engine are known, it is possible for the various steps in the FIG. 1 process to be time dependent rather than temperature dependent. Thus, rather than opening valves 80 and 56, based on reaching certain fluid or component temperatures, the operation of these valves could be based on time. It is also possible to operate the system with a combination of time and temperature.

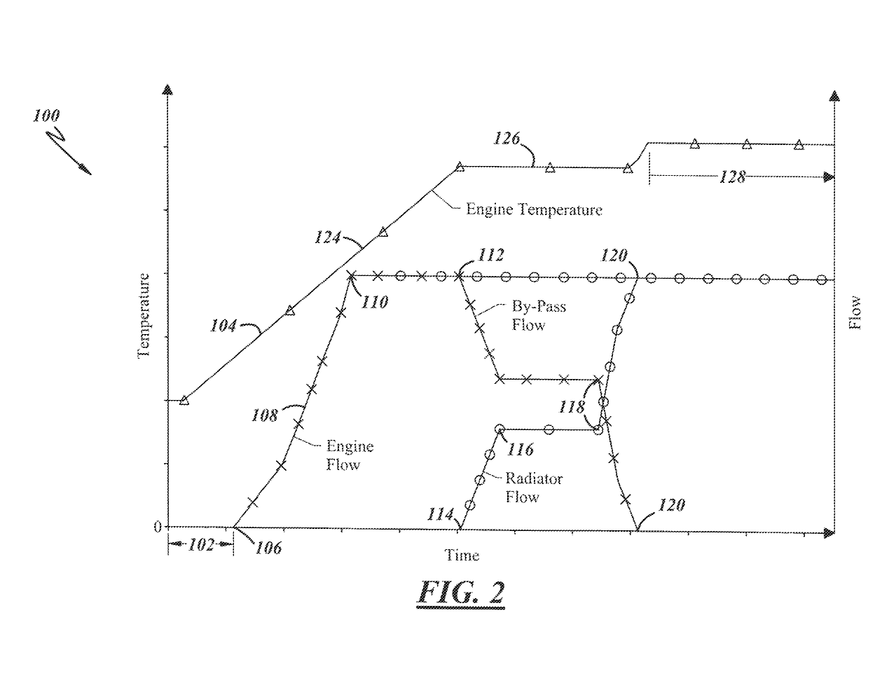

FIG. 2 depicts a graph 100 showing the warming of the engine and the coolant relative to time. This graph depicts generally the process that transpires by utilizing the layout circuit embodiment set forth in FIG. 1. The graph also could be used to conduct the steps in the warm-up process based on time.

As shown in FIG. 2, the first portion of time 102 exists where there is no flow to the engine. Valve 80 is closed. This is the starting point of a cold start for the engine. The temperature 104 of the engine heats up rapidly. At point 106, the valve 80 is opened and coolant flow is started through line 32, 34 to the engine. The coolant fluid heats up in the engine until it reaches a maximum flow 110. At point in time 112, the valve 20 starts to divert the flow from the bypass line 42 to the radiator 16.

The flow of the coolant reaches point 116 where it stays constant for a period of time as the flow of fluid through the bypass line 42 and radiator line 32. At time 118, the valve 20 further restricts the flow of coolant until it all flows to the radiator. At point 120, full flow is passing through the radiator.

Meanwhile, the temperature 124 of the engine reaches a maximum constant temperature at 126. After this, the engine and coolant are maintained at their normal operating temperatures, or temperature ranges. Under certain extreme conditions, however, the temperature of the engine can increase 128.

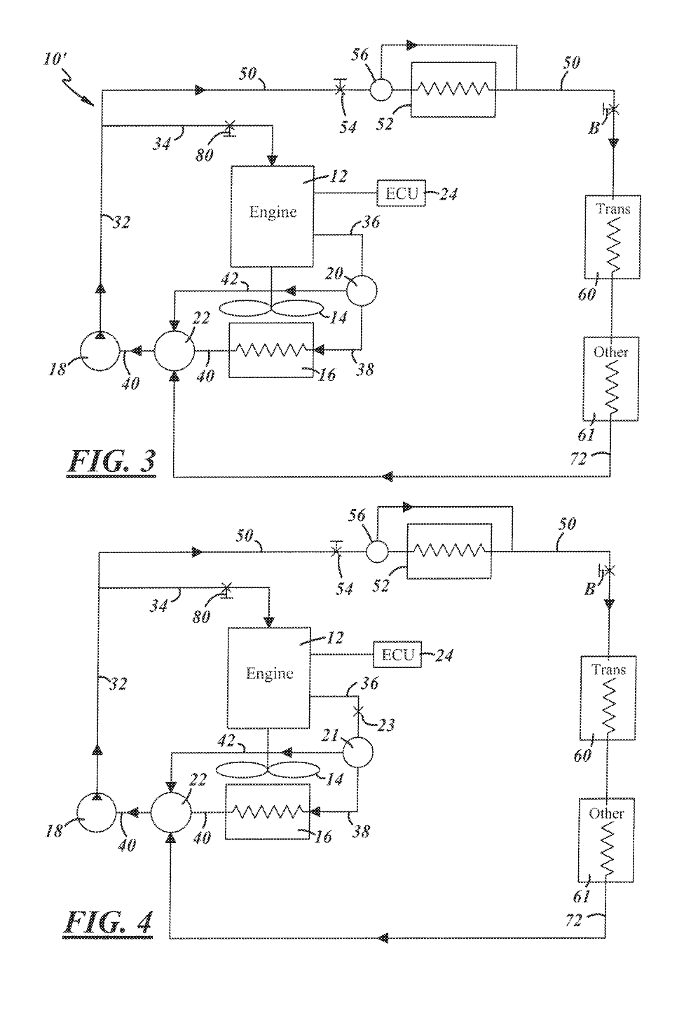

A simpler layout circuit is shown in FIG. 3 and designed by the reference number 10′. Components which are the same as these shown in FIG. 1 and described above have the same reference numbers. Through the routing of the coolant in a similar manner as set forth in FIG. 1 and with the use of shut-off valve 80, the pump 18 can be run allowing coolant to flow to the exhaust heat exchanger 52 while coolant flow to the engine is cut-off. Since there is no flow of coolant circulated through the engine block, the volume of fluid that needs to be warmed by the heat exchanger is significantly reduced.

When the vehicle engine is cold-started, the pump 18 flows coolant fluid through lines 32 and 50 where the fluid is heated by the exhaust heat exchanger 52. The fluid is then routed only through the transmission heat exchanger 60 to warm the transmission fluid and the systems of one or more other components 61 before being cycled back to the pump 18 through valve 22. After a certain time, or once the engine (or coolant in it) reaches a certain temperature, the shut-off valve 80 is opened and fluid is allowed to flow through the engine and bypass line 42. When the coolant reaches a higher temperature, the valve 20 allows coolant to flow through line 38 to the radiator. The coolant in the radiator is then circulated through the engine in a normal manner.

With the present invention, rapid coolant warm-up is achieved along with accelerated block and engine oil warm-up, as well as warm-up of selected secondary devices (a/k/a “auxiliary” devices), such as the transmission oil, rear axle oil, passenger cabin heating, etc. By excluding the volumes of cold coolant in the engine block and radiator, the exhaust heat exchangers act on a smaller volume of coolant. This allows faster heating of the devices that are being warmed, while simultaneously allowing the engine to be warmed internally.

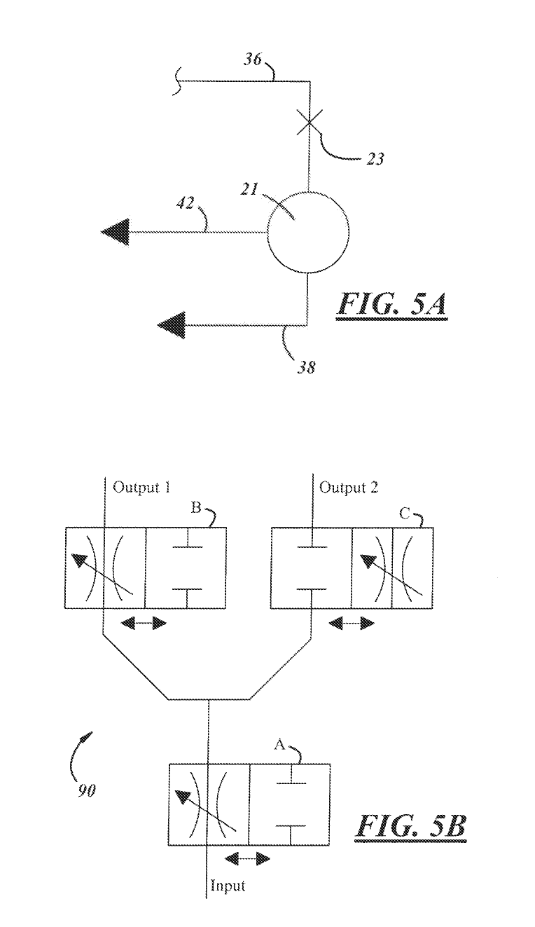

In another embodiment, the thermostat valve 20 shown in the systems of FIGS. 1 and 3 is replaced with a multifunction valve 21 which is operated by changes in the temperature of the coolant flowing into it from engine 12. This embodiment is shown in FIG. 4. In this embodiment, another shut-off valve 23 can be positioned in line 36 between the engine and the multifunction valve. The valve 23 can be operated by the ECU and, in another embodiment, can be included as part of the multifunction valve.

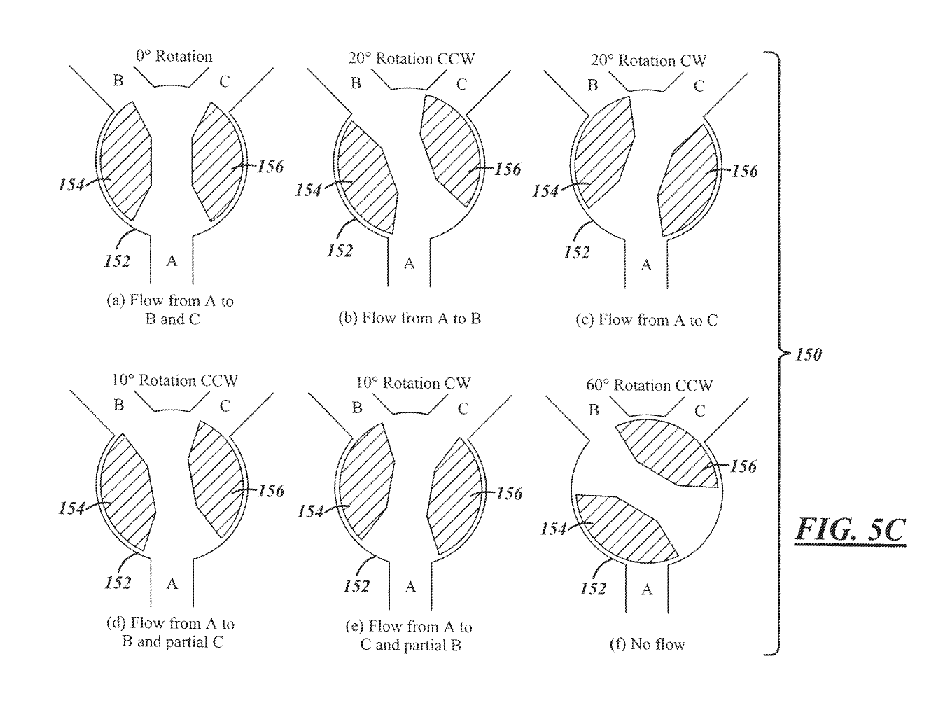

A schematic drawing of a basic valve 21, which is a three-way valve, is shown in FIG. 5A. Coolant flow through line 36 is passed to the valve 21 where it is directed either to line 42 or to line 38.

The valve 21 can be any type of conventional multifunction valve that will perform the function explained above. Solenoid valves which are controlled electronically can be used. The actuator can be in the form of a plunger or pivoted armature, often against the action of a spring or other biasing member. It can be electrically energized or de-energized and returned to its normal position by the biasing action.

Three-way valves typically have three port connections and two valve seats. One valve seal remains open and the other closed in the de-energized mode. When the solenoid coil is energized, the mode reverses. Rotating actuators with a spool inside a cylinder are common.

A schematic representation of another multifunction valve 90 which can be utilized with the present invention is shown in FIG. 5B. Three valves A, B and C are included and each one allows the fluid flow to be varied or throttled from zero flow to maximum flow. The valves are operated by the ECU or separate electronic control system. The fluid flow through valve A can be regulated to supply the desired amount of coolant flow. The “input” into valve A then is directed either to “output 1” or “output 2,” or both, as desired by the system. Also, the amount of fluid passing through valves B and C can be regulated as indicated.

Another multifunction valve 150 which can be utilized with the present invention is shown in FIG. 5C. The valve has a central housing or mixing chamber 152 and an inlet line A. The valve apportions the coolant flow in line A to flow to either lines B or C, or partially to both lines B or C. The valve can also prevent flow to both lines B and C.

The sequence of operation of the valve 150 from 0° rotation (a) to 60° rotation (f), and at various stages inbetween, (b), (c), (d) and (e), is shown in FIG. 5C. The rotation of the valve members 154 and 156 either clockwise (“CW”) or counterclockwise (“CCW”) through 10°-60° rotations are depicted.

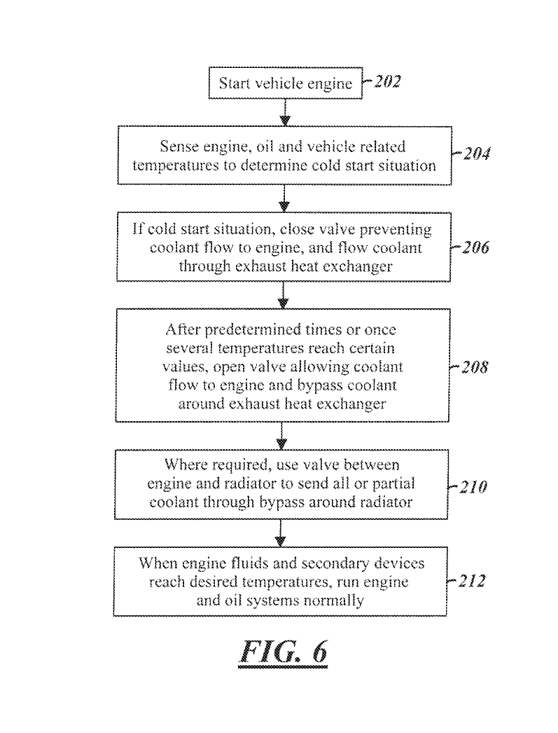

FIG. 6 depicts a cold-start process 200 for a vehicle engine in accordance with a preferred embodiment of the invention. The process 200 begins by the operator starting the engine 202. The temperatures of the engine block, engine coolant, engine oil, and other vehicle related components and systems are sensed 204 by appropriate sensors. It is also possible to sense the temperatures of the fluids and other components, such as the transmission fluid, passenger heater core, rear axle oil, etc. The temperature data is sent to the ECU or other electronic control which then decides by an appropriate look-up table or the like, the desired steps to take subsequently.

For example, the operating indicia could be to determine if one or more of the temperatures are below certain values and a cold start process is needed. (If the temperatures are all at or above prespecified values, a cold start process may not be desired and the vehicle engine, coolant and components are allowed to heat up in a normal manner.

In a cold start process in accordance with a preferred embodiment of the invention, a valve, such as valve 80 in FIG. 1, is closed 206. This blocks the coolant pumped by the coolant pump from circulating through the engine. This heats up the engine block and engine oil quickly. As indicated above, the valve 80 is opened 208 after a prespecified period of time or after the engine has reached a certain temperature.

Also, in a cold start, the coolant from the pump flows through the exhaust to coolant heat exchanger 206. The engine exhaust system heats up the coolant rapidly.

When the exhaust system gets too hot and could cause the coolant to overheat (i.e. it reaches a prespecified temperature), a bypass valve, such as valve 56 in FIG. 1, is opened 208. This allows the fluid to bypass the exhaust heat exchanger and maintain a more even temperature.

The heated coolant then passes into heat exchangers in one or more of the secondary (auxiliary) devices to allow them also to be warmed-up. As stated above, the secondary devices could be the transmission, the passenger compartment, the rear axle, etc. To complete the circulation circuit, the coolant fluid returns to the coolant pump where the cycle is repeated until the appropriate temperatures are reached or the appropriate time transpires.

When the coolant in the engine is allowed to flow and circulate toward the radiator, it may not be appropriate to allow the heated engine coolant to immediately pass through and get chilled by the large volume of coolant still in the radiator. For this reason, the valve positioned between the engine and the radiator, such as a thermostat valve or multifunction valve, can direct some or all of the heated engine coolant through a bypass line where it is circulated by the coolant pump. This is shown at 210. The coolant could be proportioned between the bypass line and radiator until the temperature of the entire coolant achieves the desired temperature or temperature range.

When the engine, the vehicle fluids and the secondary devices and systems reach their desired temperatures and ranges, the vehicle engine and systems are allowed to run normally 212.

With this process, the engine and secondary device can be all warmed-up more quickly in a cold start situation. This improves the efficiency of the engine in many ways, such as increasing fuel economy and decreasing toxic emissions.

While preferred embodiments of the present invention have been shown and described herein, numerous variations and alternative embodiments will occur to those skilled in the art. Accordingly, it is intended that the invention is not limited to the preferred embodiments described herein but instead limited to the terms of the appended claims.

What is claimed is:

1. A thermal system for a vehicle internal combustion engine comprising:
an internal combustion engine having a cooling fan and a radiator;
a coolant pump for circulating coolant through the engine and radiator;
a multifunction valve member positioned between the engine and the radiator;
a bypass circuit between said multifunction valve member and said coolant pump;
said multifunction valve member adapted to regulate and apportion coolant flow from the engine and between the radiator and the bypass circuit; and
a control system for operating the multifunction valve and regulating and apportioning the flow exiting the multifunction valve.

2. The thermal system as described in claim 1 wherein said control system comprises an ECU and at least one temperature sensor.

3. The thermal system as described in claim 1 wherein said multifunction valve member is a three-way valve.

4. The thermal system as described in claim 3 wherein said three-way valve has a rotating actuator.

5. The thermal system as described in claim 3 wherein said three-way valve comprises a plurality of varying flow valve members.

6. The thermal system as described in claim 1 further comprising a valve member positioned between the coolant pump and the engine and adapted to block flow of coolant to the engine.

7. The thermal system as described in claim 1 further comprising a valve member positioned between said engine and said multifunction valve member and adapted to block flow of coolant to the multifunction valve member.

8. The thermal system as described in claim 1 wherein said multifunction valve member is a thermostat.
